(19) United States
(12) Patent Application Publication
(10) Pub. No.: US 2015/0001204 A1
(43) Pub. Date: Jan. 1, 2015

(54) Packaged Food Steamer

(71) Applicant: Jennifer LANG, Wimberley, CA (US)

(72) Inventor: Jennifer LANG, Wimberley, CA (US)

(21) Appl. No.: 14/316,104

(22) Filed: Jun. 26, 2014

Related U.S. Application Data
(60) Provisional application No. 61/839,598, filed on Jun. 26, 2013.

(51) Int. Cl. A47J 27/04; F24C 15/32; A47J 36/00

(52) U.S. Cl. CPC A47J 27/04; A47J 36/00; F24C 15/327; A47J 2027/043
USPC 219/393; 219/401

(57) ABSTRACT

A packaged food steamer for preparing food in a meal packaging has a housing and a water reservoir. The housing includes a cooking chamber, a door and a plurality of steam injection pins being mechanically coupled to each other, and a heater for transferring heat to the water reservoir. The meal packaging is positioned within the cooking chamber, wherein upon closing the door, the plurality of steam injection pins is driven into an extended position, piercing the meal packaging. Water is heated in the water reservoir such that steam is produced which is directed to the plurality of steam injection pins through at least one steam channel. The steam then traverses through the plurality of steam injection pins into the meal packaging in order to cook the food within the meal packaging.

The current application claims a priority to the U.S. Provisional Patent application Ser. No. 61/839,598 filed on Jun. 26, 2013.

### FIELD OF THE INVENTION

The present invention relates generally to steam cooking apparatuses. More specifically, the present invention is a steam cooker that accepts single serving meals in packaging devices that are designed specifically for use with the corresponding steam cooker.

### BACKGROUND OF THE INVENTION

Steam cooking is the process by which water is vaporized into steam by continuous boiling. Food is contained within a perforated chamber that is separated from the boiling water. The steam then carries heat to the perforated chamber containing food which in turn cooks the food. The chamber is typically covered by a perforated lid that serves as a vent through which steam may escape the chamber. Steam cooking is versatile as virtually all types of food can be cooked through this technique and is favored for a wide variety of reasons. Steam cooking is considered healthy as fat intake is reduced due to the lack of cooking oil during the cooking process. Steam cooks food uniformly by slowly diffusing through the food and letting the food cook in its own juices. This allows the food to retain the majority of its nutrients while maintaining moisture, texture, and flavor throughout the process. Steam cooking apparatuses generally comprise a sealed vessel closed with a lid that retains steam within the vessel below a certain pressure. The vessel is suspended over a water reservoir that is heated by a heat source, most often a stove. Oftentimes, the water is flavored with salt, stock, herbs, juices, or seasonings. The present invention seeks to enhance and improve upon currently existing steam cooking apparatuses.

The present invention is a steam cooker that is designed for use with specially packaged single serving meals. In its preferred embodiment, the present invention comprises a housing and a water reservoir; the housing having a cooking chamber and a heater. The present invention is intended for use in conjunction with bowl or other shaped meal packaging devices that contain flash frozen food. The housing further comprises a plurality of steam injection pins that puncture the bottom surface of a meal packaging device, wherein the plurality of steam injection pins extend into the inner compartment of the meal packaging device. The water reservoir is filled with water and any desired seasonings prior to the cooking process. The water reservoir is attached to the housing and is placed adjacent to the heater. The heater is connected to a power source such as an electrical outlet, and when turned on heats the water within the water reservoir. The water is brought to a boil and vaporizes into steam, and the steam is then evenly dispersed through the plurality of steam injection pins of the housing and into the meal packaging device. The food within the meal packaging device is uniformly cooked by the heat carried by the steam. After the cooking process has concluded, the housing is opened and the meal packaging device is removed from the cooking chamber.

In the preferred embodiment of the present invention, the meal packaging devices that are used in conjunction with the steam cooker are composed of a heat resistant, compostable plant-based fiber or thermoplastic material such as polylactic acid (PLA). The meal packaging devices do not leach harmful chemicals into the food during the cooking process. As a result, the present invention maintains the health and nutritional benefits of steam cooking while integrating the concept of specially designed single serving meal packaging devices to be used in a corresponding steam cooker.

### BRIEF DESCRIPTION OF THE DRAWINGS

FIG. 1 is a perspective view of the present invention, wherein the door is in the open position and the plurality of steam injection pins is in the retracted position.

FIG. 2 is a perspective view of the present invention, wherein the door is in the closed position and the plurality of steam injection pins is in the retracted position.

FIG. 3 is a front elevational view of the present invention, wherein the height corresponding to the meal packaging is depicted.

FIG. 4 is a front sectional view of the present invention showing the plurality of steam injection pins and the water reservoir being in fluid communication through the at least one steam channel.

FIG. 5 is a right side sectional view of the present invention depicting the timer being electrically connected to the heater.

FIG. 6 is a perspective view of the present invention, wherein the heater comprises an interface plate for induction heating.

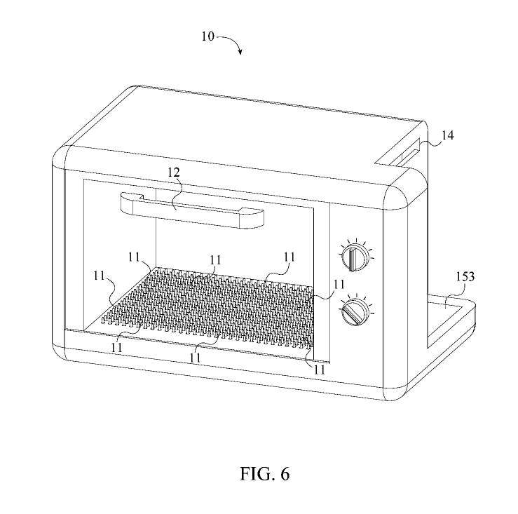

FIG. 7 is a left side sectional view of the present invention with an unopened meal packaging positioned in the cooking chamber.

FIG. 8 is a left side sectional view of the present invention, wherein the plurality of steam injection pins has pierced through the meal packaging.

FIG. 9 is a left side sectional view of the present invention, wherein a clamping mechanism is in the unclamped position as the door is in the open position.

FIG. 10 is a left side sectional view of the present invention, wherein the clamping mechanism is in the clamped position as the door is in the closed position.

### DETAIL DESCRIPTIONS OF THE INVENTION

All illustrations of the drawings are for the purpose of describing selected versions of the present invention and are not intended to limit the scope of the present invention.

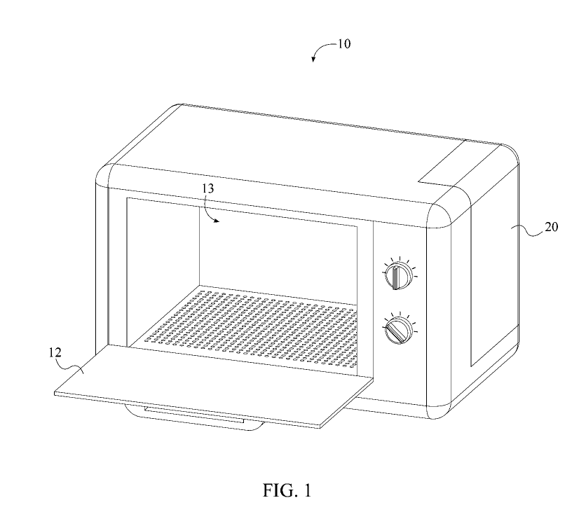

The present invention is a packaged food steamer that is used to prepare food that is provided in a meal packaging 30. In reference to FIG. 1, the present invention comprises a housing 10 and a water reservoir 20, wherein the housing 10 provides a means for securing the meal packaging 30 and the water reservoir 20 provides storage for a quantity of water to be converted into steam. The present invention can either be designed as a countertop device or as a hanging installation, such as being positioned above a stovetop.

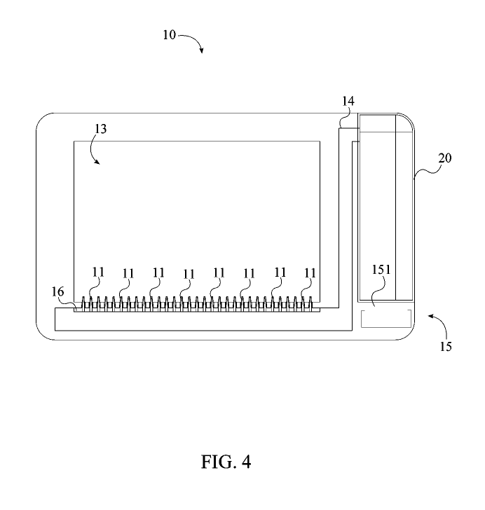

The housing 10 comprises a plurality of steam injection pins 11, a door 12, a cooking chamber 13, at least one steam channel 14, and a heater 15. The water reservoir 20 is adjacently attached to the housing 10, and is positioned adjacent to the heater 15, wherein the heater 15 is in thermal communication with the water reservoir 20 such that water within the water reservoir 20 can be heated and converted into steam. The plurality of steam injection pins 11 is in fluid communication with the water reservoir 20 through the at least one steam channel 14, as depicted in FIG. 4, wherein the plurality of steam injection pins 11 is positioned along the cooking chamber 13 in order to deliver steam into the cooking chamber 13. The door 12 is positioned laterally about the housing 10 and adjacent to the cooking chamber 13. The door 12 provides a means for accessing the cooking chamber 13 into which the meal packaging 30 is positioned for cooking, wherein the door 12 has an open position and a closed position relative to the cooking chamber 13.

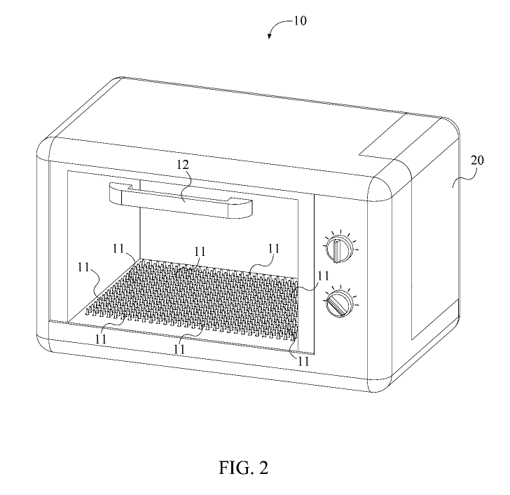

In reference to FIG. 1-2, the plurality of steam injection pins 11 is bistably positioned within the housing 10, wherein the plurality of steam injection pins 11 has an extended position and a retracted position relative to the cooking chamber 13. In the extended position, the plurality of steam injection pins 11 is positioned into the cooking chamber 13, wherein the plurality of steam injection pins 11 extends outwards from an inner surface of the housing 10, as shown in FIG. 2. In the retracted position, the plurality of steam injection pins 11 is positioned below the inner surface, wherein the plurality of steam injection pins 11 is inaccessible a user, thus preventing injury to the user, as shown in FIG. 1. In the preferred embodiment of the present invention, the plurality of steam injection pins 11 is positioned along the bottom of the cooking chamber 13, however, it is possible for the plurality of steam injection pins 11 to be positioned along any other side of the cooking chamber 13.

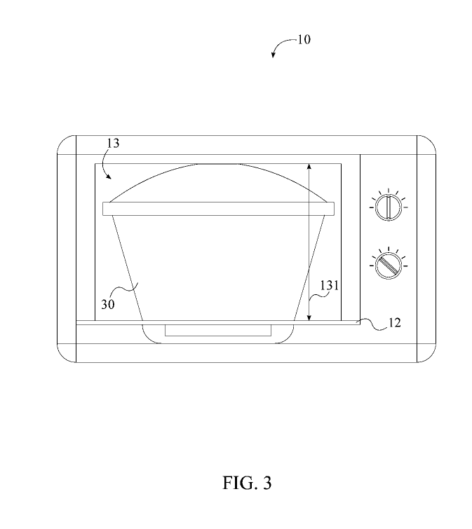

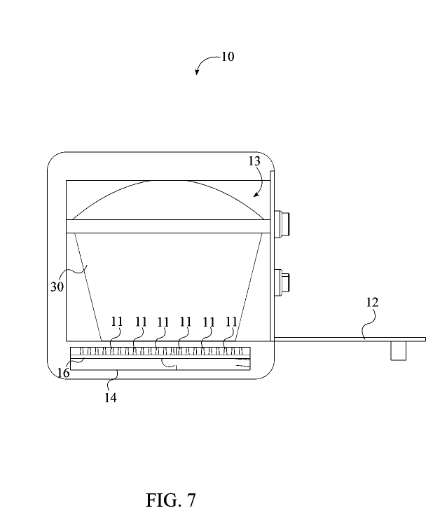

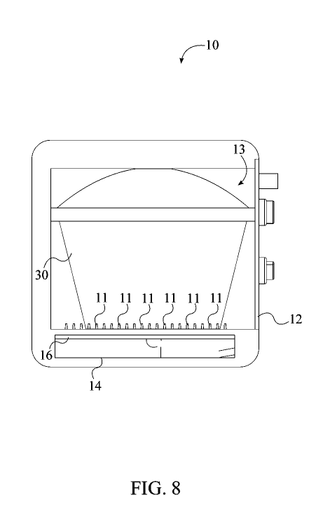

Each of the plurality of steam injection pins 11 is hollow and open about each end, such that steam may travel through each of the plurality of steam injection pins 11 from the steam channel to the cooking chamber 13, as shown in FIG. 3. Additionally, as depicted in FIG. 7-8, the plurality of steam injection pins 11 is mechanically coupled to the door 12, wherein the plurality of steam injection pins 11 is in the extended position when the door 12 is in the closed position and in the retracted position when the door 12 is in the open position. In this way, the meal packaging 30 can safely be placed within the cooking chamber 13 and the meal packaging 30 is automatically opened as the door 12 is closed and the plurality of steam injection pins 11 are driven into the meal packaging 30.

In the preferred embodiment of the present invention, each of the plurality of steam injection pins 11 is conical in order to allow the plurality of steam injection pins 11 to pierce the meal packaging 30.

In reference to FIG. 7-8, the housing 10 further comprises a lift plate that is mechanically coupled to the door 12. The plurality of steam injection pins 11 is adjacently connected to the lift plate, wherein the plurality of steam injection pins 11 is mechanically coupled to the door 12 through the lift plate. The lift plate allows each of the plurality of steam injection pins 11 to be driven towards and away from the meal packaging 30 in unison with a single force. The lift plate may be mechanically coupled to the door 12 through the use of a mechanical linkage and/or a plurality of gears positioned within the housing 10.

In reference to FIG. 3, the cooking chamber 13 has a height 131 corresponding to the meal packaging 30. The height 131 ensures the snug fit of the meal packaging 30 within the cooking chamber 13, such that when the plurality of steam injection pins 11 is driven into the meal packaging 30 the meal packaging 30 cannot move, thus allowing the plurality of steam injection pins 11 to pierce the meal packaging 30. If the present invention is designed such that the plurality of steam injection pins 11 is positioned about one of the sides of the cooking chamber 13, then the cooking chamber 13 will have a width or depth corresponding to the meal package as opposed to the height 131. The size and shape of the cooking chamber 13 is limited only to accommodate for the size and shape of the meal packaging 30.

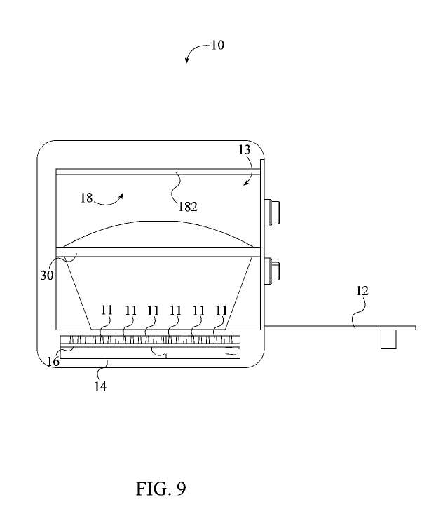

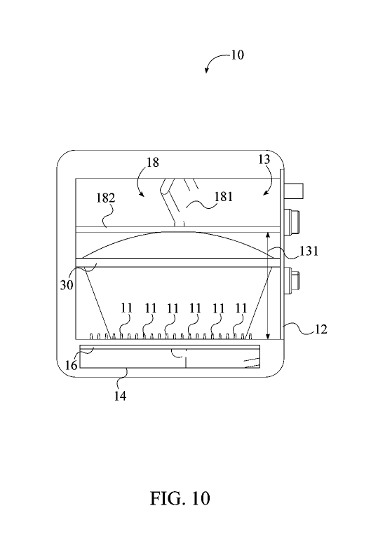

In an alternative embodiment of the present invention, the housing 10 further comprises a clamping mechanism 18, wherein the clamping mechanism 18 has a clamped position and an unclamped position, as depicted in FIG. 10 and FIG. 9 respectively. The clamping mechanism 18 is mechanically coupled to the door 12, wherein the clamping mechanism 18 is in the clamped position when the door 12 is in the closed position and in the unclamped position when the door 12 is in the open position. Similar to the lift plate, the clamping mechanism 18 may be mechanically coupled to the door 12 through the use of a mechanical linkage and/or a plurality of gears positioned within the housing 10.

In reference to FIG. 9-10, the clamping mechanism 18 comprises a retractable arm 181 and a pressure contact 182, wherein the pressure contact 182 is connected to the retractable arm 181. The pressure contact 182 provides a surface for engaging the meal packaging 30, while the retractable arm 181 allows the pressure contact 182 to extend away from the inner surface of the housing 10 and apply pressure to the meal packaging 30. In this way, the clamping mechanism 18 allows the cooking chamber 13 to have a greater height 131, width, or depth than the meal packaging 30, and acts to secure the meal packaging 30 in place within the cooking chamber 13, such that the plurality of steam injection pins 11 may pierce the meal packaging 30.

In one embodiment of the present invention, the water reservoir 20 is attached to the housing 10 below the cooking chamber 13. The water reservoir 20 is slid into place, wherein there is an opening below the plurality of steam injection pins 11 serving as the at least one steam channel 14. The heater 15 can be positioned below the water reservoir 20 or around the sides of the water reservoir 20. As the heater 15 heats the water in the water reservoir 20, the water is converted to steam, which then rises up through the at least one steam channel 14, through the plurality of steam injection pins 11, and into the cooking chamber 13. Water in the water reservoir 20 can readily be replaced or refilled by sliding the water reservoir 20 in and out of the housing 10.

In another embodiment of the present invention, the water reservoir 20 is attached to one of the sides of the housing 10. The water reservoir 20 can be positioned down into a portion of the housing 10, slid into the housing 10, or attached otherwise. The heater 15 can be positioned below the water reservoir 20 or along one of the sides of the water reservoir 20 adjacent to the housing 10. The at least one steam channel 14 should be positioned above the water level in the water reservoir 20 such that when water is heated, the steam may rise and traverse through the at least one water channel to the plurality of steam injection pins 11.

It is also possible for the water reservoir 20 to be permanently connected to the housing 10, wherein an opening is provided in the water reservoir 20 in order to refill the water reservoir 20. A plug, cap, or similar device can be used to secure the opening closed once the water reservoir 20 has been filled. The water reservoir 20 may also comprise a filter 21. The filter 21 is positioned within the water reservoir 20 such that incoming water is passed over the filter 21 or such that outgoing steam passes through the filter 21.

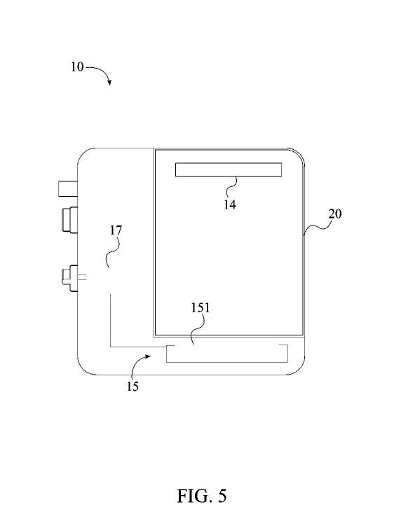

In reference to FIG. 4-5, in the preferred embodiment of the present invention, the heater 15 comprises a coiled heating element 151 that is electrically connected to a power supply. The power supply directs current to the coiled heating element 151, wherein the resistance of the coiled heating element 151 causes the coiled heating element 151 to produce heat, which is then transferred to the water reservoir 20. A power cord is electrically connected to the power supply, such that energy from an outlet or similar source can be supplied to the power supply. It is also possible for the power supply to be connected to a portable power source such as a battery.

The heater 15 may further comprise a rheostat 152 that is used in conjunction with the coiled heating element 151. The rheostat 152 allows a user to adjust the resistance of the coiled heating element 151, and thus control the amount of heat produced from the coiled heating element 151. As such, the rheostat 152 is controllable through the housing 10 through a turn knob, push button, digital display, or any other appropriate means of control.

In an alternative embodiment of the present invention, the heater 15 provides a means for inductive heating, wherein the heater 15 comprises the coiled heating element 151 and a interface plate 153. The interface plate 153 is positioned into the housing 10, while the coiled heating element 151 is positioned adjacent to the interface plate 153. The coiled heating element 151 is a copper wire, or similar material, wherein alternating current is passed through the coiled heating element 151 in order to produce an oscillating magnetic field. The water reservoir 20 must be constructed from a ferromagnetic material such that the oscillating magnetic field is able to induce an electric current in the water reservoir 20, which in turn produces resistive heating in the water reservoir 20 to heat the water. The interface plate 153 should be made from poor heat conducting material such that little heat is lost through the bottom of the water reservoir 20.

In reference to FIG. 5, the housing 10 may further comprise a timer 17. The timer 17 is electronically connected to the coiled heating element 151 and/or the power supply and allows current to be delivered to the coiled heating element 151 for a predetermined amount of time. The timer 17 can offer preselected times such as a frozen time and a thawed time for preparing frozen and thawed food respectively, a cleaning time for performing a self-cleaning operation of the cooking chamber 13, or the ability for the user to set the predetermined amount of time for which the timer 17 is operated. Similar to the rheostat 152, the timer 17 is controllable through the housing 10 using a knob, push button, digital display, or any other appropriate means of control.

The following is to describe the preferred use of the present invention. The meal packaging 30 containing a desired food is selected and inserted into the cooking chamber 13. Upon closing the door 12, the plurality of steam injection pins 11 pierces the meal packaging 30, wherein the meal packaging 30 is in fluid communication with the water reservoir 20. A power switch is actuated by the user, wherein current is then supplied to the heater 15. As the heater 15 produces heat, the heat is transferred to the water reservoir 20, in turn heating the water inside the water reservoir 20. The water is then converted into steam, which then traverses through the at least one steam channel 14, through the plurality of steam injection pins 11 and into the meal packaging 30 within the cooking chamber 13. After the food has been cooked, water in the water reservoir 20 may be removed and discarded or added to the cooked meal if desired.

Preferably, the meal packaging 30 is a disposable container made of biodegradable materials and contains prepackaged food. However, it is also possible for a meal packaging 30 to be designed that is reusable and can be filled with a product selected by the user. The meal packaging 30 would comprise a plurality of holes, wherein the plurality of holes is aligned with the plurality of steam injection pins 11, such that the steam can be injected into the meal packaging 30.

Although the invention has been explained in relation to its preferred embodiment, it is to be understood that many other possible modifications and variations can be made without departing from the spirit and scope of the invention as hereinafter claimed.

What is claimed is:

1. A steam cooker comprises:
a housing;
a water reservoir;
the housing comprises a plurality of steam injection pins, a door, a cooking chamber, and a heater;
the water reservoir being adjacently attached to the housing;
the water reservoir being positioned adjacent to the heater;
the heater being in thermal communication with the water reservoir;
the plurality of steam injection pins being in fluid communication with the water reservoir;
the plurality of steam injection pins being bistably positioned within the housing, wherein the plurality of steam injection pins have an extended position and a retracted position relative to the cooking chamber;
the door being positioned adjacent to the cooking chamber, wherein the door has an open position and a closed position relative to the cooking chamber; and
the plurality of steam injection pins being mechanically coupled to the door, wherein the plurality of steam injection pins is in the extended position when the door is in the closed position and in the retracted position when the door is in the open position.

2. The steam cooker as claimed in claim 1 comprises:
the plurality of steam injection pins being positioned into the cooking chamber, wherein the plurality of pins is in the extended position.

3. The steam cooker as claimed in claim 1 comprises:
the plurality of steam injection pins being conical.

4. The steam cooker as claimed in claim 1 comprises:
the housing further comprises a lift plate;
the plurality of steam injection pins being adjacently connected to the lift plate; and
the lift plate being mechanically coupled to the door.

5. The steam cooker as claimed in claim 1 comprises:
the housing further comprises a timer; and
the timer being electrically connected to the heater.

6. The steam cooker as claimed in claim 1 comprises:
the housing further comprises a clamping mechanism, wherein the clamping mechanism has a clamped position and an unclamped position relative to the cooking chamber; and
the clamping mechanism being mechanically coupled to the door, wherein the clamping mechanism is in the clamped position when the door is in the closed position and in the unclamped position when the door is in the open position.

7. The steam cooker as claimed in claim 1 comprises:
the heater comprises a rheostat; and
the rheostat being controllable through the housing.

8. The steam cooker as claimed in claim 1 comprises:
the cooking chamber having a height corresponding to a meal packaging.

9. The steam cooker as claimed in claim 1 comprises:
the housing further comprises at least one steam channel; and
the plurality of steam injection pins and the water reservoir being in fluid communication through the at least one steam channel.

10. The steam cooker as claimed in claim 1 comprises:
a meal packaging; and
the meal packaging being positioned within the cooking chamber.

11. The steam cooker as claimed in claim 10 comprises:
the plurality of steam injecting pins piercing the meal packaging, wherein the plurality of steam injection pins is in the extended position; and
the meal packaging being in fluid communication with the water reservoir through the plurality of steam injection pins.

12. The steam cooker as claimed in claim 1 comprises:
the water reservoir being constructed from a ferromagnetic material.

13. A steam cooker comprises:
a housing;
a water reservoir;
the housing comprises a plurality of steam injection pins, a door, a cooking chamber, a heater, a timer, and at least one steam channel;
the cooking chamber having a height corresponding to a meal packaging;
the water reservoir being adjacently attached to the housing;
the water reservoir being positioned adjacent to the heater;
the heater being in thermal communication with the water reservoir;
the plurality of steam injection pins and the water reservoir being in fluid communication through the at least one steam channel;
the plurality of steam injection pins being bistably positioned within the housing, wherein the plurality of steam injection pins have an extended position and a retracted position relative to the cooking chamber;
the door being positioned adjacent to the cooking chamber, wherein the door has an open position and a closed position relative to the cooking chamber;
the plurality of steam injection pins being mechanically coupled to the door, wherein the plurality of steam injection pins is in the extended position when the door is in the closed position and in the retracted position when the door is in the open position; and
the timer being electrically connected to the heater.

14. The steam cooker as claimed in claim 13 comprises:
the plurality of steam injection pins being positioned into the cooking chamber, wherein the plurality of pins is in the extended position.

15. The steam cooker as claimed in claim 13 comprises:
the plurality of steam injection pins being conical.

16. The steam cooker as claimed in claim 13 comprises:
the housing further comprises a lift plate;
the plurality of steam injection pins being adjacently connected to the lift plate; and
the lift plate being mechanically coupled to the door.

17. The steam cooker as claimed in claim 13 comprises:
the housing further comprises a clamping mechanism, wherein the clamping mechanism has a clamped position and an unclamped position relative to the cooking chamber; and
the clamping mechanism being mechanically coupled to the door, wherein the clamping mechanism is in the clamped position when the door is in the closed position and in the unclamped position when the door is in the open position.

18. The steam cooker as claimed in claim 13 comprises:
the heater comprises a rheostat; and
the rheostat being controllable through the housing.

19. The steam cooker as claimed in claim 13 comprises:
the meal packaging being positioned within the cooking chamber.

20. The steam cooker as claimed in claim 19 comprises:
the plurality of steam injecting pins piercing the meal packaging, wherein the plurality of steam injection pins is in the extended position; and
the meal packaging being in fluid communication with the water reservoir through the plurality of steam injection pins.
